(19) United States
(12) Patent Application Publication
(10) Pub. No.: US 2005/0126594 A1
(43) Pub. Date: Jun. 16, 2005

(54) Soot blower access apparatus

(76) Inventors: Blake C. Chenevert, Redmond, WA (US); Donald W. Kendrick, Bellevue, WA (US); Raymond N. Henderson, Federal Way, WA (US); Scott A. Flatness, Seattle, WA (US)

Correspondence Address: BACHMAN & LAPOINTE, P.C., 900 CHAPEL STREET, SUITE 1201, NEW HAVEN, CT, 06510, US

(21) Appl. No.: 10/733,533

(22) Filed: Dec. 11, 2003

(51) Int. Cl. B08B 7/00

(52) U.S. Cl. 134/19; 134/94.1; 134/201

(57) ABSTRACT

An apparatus for providing detonative cleaning through a vessel wall has a first conduit extending through the wall. A first valve has an open condition permitting communication through the first conduit and a closed condition. A second conduit has an insertion portion dimensioned to be received within a receiving portion of the first conduit. A second valve has an open condition permitting communication through the second conduit and a closed condition.

### BACKGROUND OF THE INVENTION

(1) Field of the Invention

The invention relates to industrial equipment. More particularly, the invention relates to the cleaning of industrial equipment.

(2) Description of the Related Art

Surface fouling is a major problem in industrial equipment. Such equipment includes furnaces (coal, oil, waste, etc.), boilers, gasifiers, reactors, heat exchangers, and the like. Typically the equipment involves a vessel containing internal heat transfer surfaces that are subjected to fouling by accumulating particulate such as soot, ash, minerals and other products and byproducts of combustion, more integrated buildup such as slag and/or fouling, and the like. Such particulate build-up may progressively interfere with plant operation, reducing efficiency and throughput and potentially causing damage. Cleaning of the equipment is therefore highly desirable and is attended by a number of relevant considerations. Often direct access to the fouled surfaces is difficult. Additionally, to maintain revenue it is desirable to minimize industrial equipment downtime and related costs associated with cleaning. A variety of technologies have been proposed. By way of example, various technologies have been proposed in U.S. Pat. Nos. 5,494,004 and 6,438,191 and U.S. patent application Publication 2002/0112638. Additional technology is disclosed in Huque, Z. Experimental Investigation of Slag Removal Using Pulse Detonation Wave Technique, DOE/HBCU/OMI Annual Symposium, Miami, Fla., Mar. 16-18, 1999. Particular blast wave techniques are described by Hanjalić and Smajević in their publications: Hanjalić, K. and Smajević, I., Further Experience Using Detonation Waves for Cleaning Boiler Heating Surfaces, International Journal of Energy Research Vol. 17, 583-595 (1993) and Hanjalić, K. and Smajević, I., Detonation-Wave Technique for On-load Deposit Removal from Surfaces Exposed to Fouling: Parts I and II, Journal of Engineering for Gas Turbines and Power, Transactions of the ASME, Vol. 1, 116 223-236, January 1994. Such systems are also discussed in Yugoslav patent publications P 1756/88 and P 1728/88. Such systems are often identified as “soot blowers” after an exemplary application for the technology.

Nevertheless, there remain opportunities for further improvement in the field.

### SUMMARY OF THE INVENTION

One aspect of the invention is directed to an apparatus for providing detonative cleaning communication through a vessel wall. A first conduit extends from the vessel wall. A first valve has an open condition permitting communication through the first conduit and a closed condition. A second conduit has an insertion portion dimensioned to be received within a receiving portion of the first conduit. A second valve has an open condition permitting communication through the second conduit and a closed condition.

In various implementations, one valve may be a sliding gate valve and the other valve may be a sliding gate valve or a hinged gate valve. One of the valves may be manually-actuated or machine-actuated and the other may manually-actuated or machine-actuated. There may be means for sealing the first conduit relative to the second conduit over a first range of insertion of the second conduit within the first conduit. The second conduit may have an interior surface off-axis to an exterior surface.

Another aspect of the invention involves an apparatus for providing detonative cleaning communication through a vessel wall. A conduit defines a flow path through the vessel wall. A valve along the flow path has an open condition and a closed condition.

In various implementations, a source of fuel and oxidizer may be coupled to the conduit. Means may ignite charges of the fuel and the oxidizer. The valve may be secured relative to the wall. The valve may be along a downstream half of the flow path. The valve may be a first valve at an upstream end of an access conduit. The apparatus may include a second valve along the conduit upstream of the first valve and upstream of an insertion portion of the conduit within the access conduit. The valve may be a first valve between a main portion of the conduit and a downstream insertion portion of the conduit. The apparatus may include a second valve at an upstream end of an access conduit receiving the insertion portion.

Another aspect of the invention involves a method for cleaning a surface within a vessel. The vessel has a wall and an access conduit initially sealed by a first valve. An insertion portion of a combustion conduit is inserted into the access conduit. The combustion conduit has a second valve. A seal is formed between the access conduit and the combustion conduit. The first valve is opened. The second valve is opened. Combustion gases are passed through the combustion conduit into the vessel. The insertion portion is withdrawn from the access conduit.

In various implementations, the first valve may be opened during an intermediate stage of the insertion. A seal may be formed between the combustion conduit and the access conduit. The seal may be formed before the opening of the first valve. The opening one valve may comprise a pivotal movement of a gate of that valve. The opening of the other valve may be manual.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of an industrial furnace associated with several soot blowers positioned to clean a level of the furnace.

FIG. 2 is a side view of one of the blowers of FIG. 1.

FIG. 3 is a partially cut-away side view of an upstream end of the blower of FIG. 2.

FIG. 4 is a longitudinal sectional view of a main combustor segment of the soot blower of FIG. 2.

FIG. 5 is an end view of the segment of FIG. 4.

FIG. 6 is a partial sectional view of a combustion conduit outlet end and furnace access apparatus combination in an initial stage of interaction.

FIG. 7 is a view of the combination of FIG. 6 in a final stage of interaction.

FIG. 8 is a partial sectional view of a second combustion conduit outlet end and furnace access apparatus combination in an initial stage of interaction.

FIG. 9 is a view of the combination of FIG. 8 in a final stage of interaction.

FIG. 10 is a partial sectional view of a third combustion conduit outlet end and furnace access apparatus combination in an initial stage of interaction.

FIG. 11 is a view of the combination of FIG. 10 in a final stage of interaction.

FIG. 12 is a partial sectional view of a fourth combustion conduit outlet end and furnace access apparatus combination in a final stage of interaction.

FIG. 13 is a view of a fifth access apparatus.

FIG. 14 is an exploded, partially sectional, side view of a fifth combustion conduit outlet end.

FIG. 15 is a view of the access apparatus of FIG. 13 and conduit outlet end of FIG. 14 in a first intermediate stage of assembly.

FIG. 16 is a view of the access apparatus and outlet end of FIG. 15 in a second intermediate stage of assembly.

FIG. 17 is a view of the access apparatus and combustion conduit outlet end of FIG. 15 in a final stage of assembly.

FIG. 18 is a partial sectional view of a sixth combustion conduit outlet end and furnace access apparatus combination in a final stage of interaction.

Like reference numbers and designations in the various drawings indicate like elements.

### DETAILED DESCRIPTION

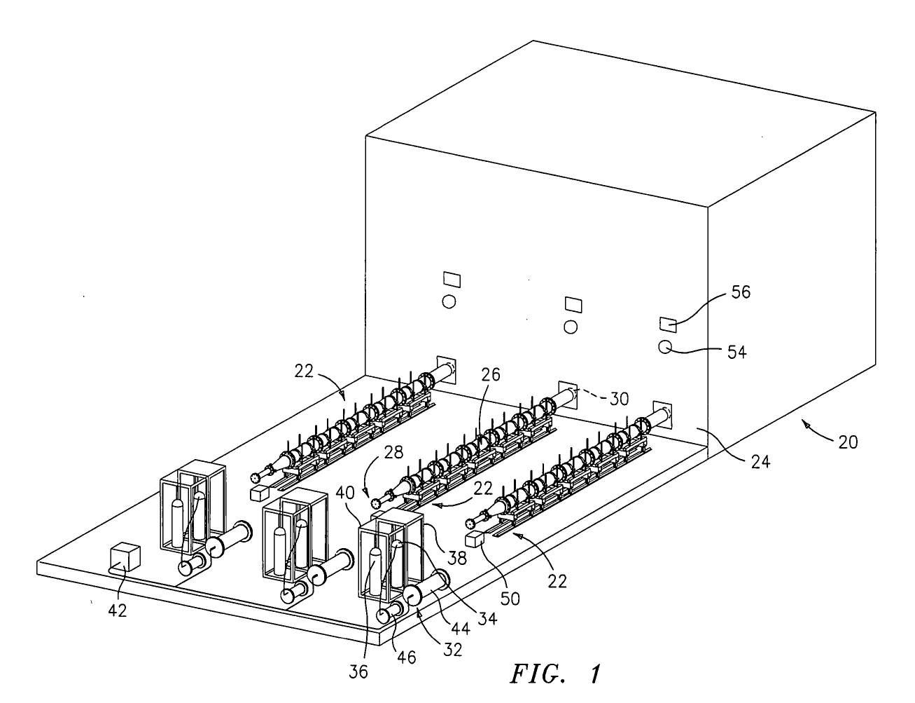

FIG. 1 shows a furnace 20 having an exemplary three associated soot blowers 22. In the illustrated embodiment, the furnace vessel is formed as a right parallelepiped and the soot blowers are all associated with a single common wall 24 of the vessel and are positioned at like height along the wall. Other configurations are possible (e.g., a single soot blower, one or more soot blowers on each of multiple levels, and the like).

Each soot blower 22 includes an elongate combustion conduit 26 extending from an upstream distal end 28 away from the furnace wall 24 to a downstream proximal end 30 closely associated with the wall 24. Optionally, however, the end 30 may be well within the furnace. In operation of each soot blower, combustion of a fuel/oxidizer mixture within the conduit 26 is initiated proximate the upstream end (e.g., within an upstreammost 10% of a conduit length) to produce a detonation wave which is expelled from the downstream end as a shock wave along with associated combustion gases for cleaning surfaces within the interior volume of the furnace. Each soot blower may be associated with a fuel/oxidizer source 32. Such source or one or more components thereof may be shared amongst the various soot blowers. An exemplary source includes a liquified or compressed gaseous fuel cylinder 34 and an oxygen cylinder 36 in respective containment structures 38 and 40. In the exemplary embodiment, the oxidizer is a first oxidizer such as essentially pure oxygen. A second oxidizer may be in the form of shop air delivered from a central air source 42. In the exemplary embodiment, air is stored in an air accumulator 44. Fuel, expanded from that in the cylinder 34 is generally stored in a fuel accumulator 46. Each exemplary source 32 is coupled to the associated conduit 26 by appropriate plumbing below. Similarly, each soot blower includes a spark box 50 for initiating combustion of the fuel oxidizer mixture and which, along with the source 32, is controlled by a control and monitoring system (not shown). FIG. 1 further shows the wall 24 as including a number of ports for inspection and/or measurement. Exemplary ports include an optical monitoring port 54 and a temperature monitoring port 56 associated with each soot blower 22 for respectively receiving an infrared and/or visible light video camera and thermocouple probe for viewing the surfaces to be cleaned and monitoring internal temperatures. Other probes/monitoring/sampling may be utilized, including pressure monitoring, composition sampling, and the like.

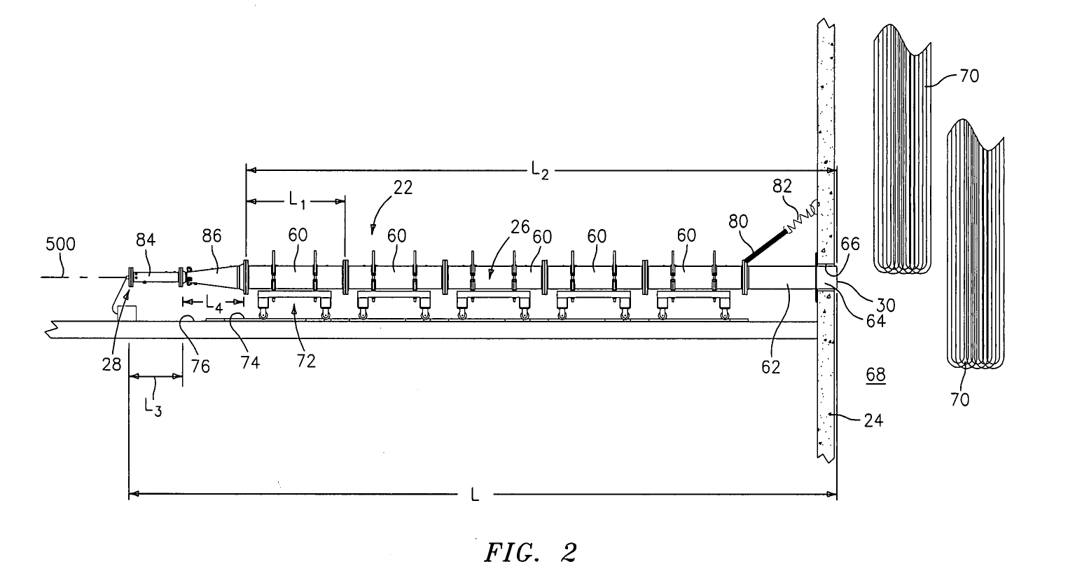

FIG. 2 shows further details of an exemplary soot blower 22. The exemplary detonation conduit 26 is formed with a main body portion formed by a series of doubly flanged conduit sections or segments 60 arrayed from upstream to downstream and a downstream nozzle conduit section or segment 62 having a downstream portion 64 extending through an aperture 66 in the wall and ending in the downstream end or outlet 30 exposed to the furnace interior 68. The term nozzle is used broadly and does not require the presence of any aerodynamic contraction, expansion, or combination thereof. Exemplary conduit segment material is metallic (e.g., stainless steel). The outlet 30 may be located further within the furnace if appropriate support and cooling are provided. FIG. 2 further shows furnace interior tube bundles 70, the exterior surfaces of which are subject to fouling. In the exemplary embodiment, each of the conduit segments 60 is supported on an associated trolley 72, the wheels of which engage a track system 74 along the facility floor 76. The exemplary track system includes a pair of parallel rails engaging concave peripheral surfaces of the trolley wheels. The exemplary segments 60 are of similar length L₁ and are bolted end-to-end by associated arrays of bolts in the bolt holes of their respective flanges. Similarly, the downstream flange of the downstreammost of the segments 60 is bolted to the upstream flange of the nozzle 62. In the exemplary embodiment, a reaction strap 80 (e.g., cotton or thermally/structurally robust synthetic) in series with one or more metal coil reaction springs 82 is coupled to this last mated flange pair and connects the combustion conduit to an environmental structure such as the furnace wall for resiliently absorbing reaction forces associated with discharging of the soot blower and ensuring correct placement of the combustion conduit for subsequent firings. Optionally, additional damping (not shown) may be provided. The reaction strap/spring combination may be formed as a single length or a loop. In the exemplary embodiment, this combined downstream section has an overall length L₂.

Extending downstream from the upstream end 28 is a predetonator conduit section/segment 84 which also may be doubly flanged and has a length L₃. The predetonator conduit segment 84 has a characteristic internal cross-sectional area (transverse to an axis/centerline 500 of the conduit) which is smaller than a characteristic internal cross-sectional area (e.g., mean, median, mode, or the like) of the downstream portion (60, 62) of the combustion conduit. In an exemplary embodiment involving circular sectioned conduit segments, the predetonator cross-sectional area is a characterized by a diameter of between 8 cm and 12 cm whereas the downstream portion is characterized by a diameter of between 20 cm and 40 cm. Accordingly, exemplary cross-sectional area ratios of the downstream portion to the predetonator segment are between 1:1 and 10:1, more narrowly, 2:1 and 10:1. An overall length L between ends 28 and 30 may be 1-15 m, more narrowly, 5-15 m. In the exemplary embodiment, a transition conduit segment 86 extends between the predetonator segment 84 and the upstreammost segment 60. The segment 86 has upstream and downstream flanges sized to mate with the respective flanges of the segments 84 and 60 has an interior surface which provides a smooth transition between the internal cross-sections thereof. The exemplary segment 86 has a length L₄. An exemplary half angle of divergence of the interior surface of segment 86 is ≦12°, more narrowly 5-10°.

A fuel/oxidizer charge may be introduced to the detonation conduit interior in a variety of ways. There may be one or more distinct fuel/oxidizer mixtures. Such mixture(s) may be premixed external to the detonation conduit, or may be mixed at or subsequent to introduction to the conduit. FIG. 3 shows the segments 84 and 86 configured for distinct introduction of two distinct fuel/oxidizer combinations: a predetonator combination; and a main combination. In the exemplary embodiment, in an upstream portion of the segment 84, a pair of predetonator fuel injection conduits 90 are coupled to ports 92 in the segment wall which define fuel injection ports. Similarly, a pair of predetonator oxidizer conduits 94 are coupled to oxidizer inlet ports 96. In the exemplary embodiment, these ports are in the upstream half of the length of the segment 84. In the exemplary embodiment, each of the fuel injection ports 92 is paired with an associated one of the oxidizer ports 96 at even axial position and at an angle (exemplary 90° shown, although other angles including 180° are possible) to provide opposed jet mixing of fuel and oxidizer. Discussed further below, a purge gas conduit 98 is similarly connected to a purge gas port 100 yet further upstream. An end plate 102 bolted to the upstream flange of the segment 84 seals the upstream end of the combustion conduit and passes through an igniter/initiator 106 (e.g., a spark plug) having an operative end 108 in the interior of the segment 84.

In the exemplary embodiment, the main fuel and oxidizer are introduced to the segment 86. In the illustrated embodiment, main fuel is carried by a number of main fuel conduits 112 and main oxidizer is carried by a number of main oxidizer conduits 110, each of which has terminal portions concentrically surrounding an associated one of the fuel conduits 112 so as to mix the main fuel and oxidizer at an associated inlet 114. In exemplary embodiments, the fuels are hydrocarbons. In particular exemplary embodiments, both fuels are the same, drawn from a single fuel source but mixed with distinct oxidizers: essentially pure oxygen for the predetonator mixture; and air for the main mixture. Exemplary fuels useful in such a situation are propane, MAPP gas, or mixtures thereof. Other fuels are possible, including ethylene and liquid fuels (e.g., diesel, kerosene, and jet aviation fuels). The oxidizers can include mixtures such as air/oxygen mixtures of appropriate ratios to achieve desired main and/or predetonator charge chemistries. Further, monopropellant fuels having molecularly combined fuel and oxidizer components may be options.

In operation, at the beginning of a use cycle, the combustion conduit is initially empty except for the presence of air (or other purge gas). The predetonator fuel and oxidizer are then introduced through the associated ports filling the segment 84 and extending partially into the segment 86 (e.g., to near the midpoint) and advantageously just beyond the main fuel/oxidizer ports. The predetonator fuel and oxidizer flows are then shut off. An exemplary volume filled the predetonator fuel and oxidizer is 1-40%, more narrowly 1-20%, of the combustion conduit volume. The main fuel and oxidizer are then introduced, to substantially fill some fraction (e.g., 20-100%) of the remaining volume of the combustor conduit. The main fuel and oxidizer flows are then shut off. The prior introduction of predetonator fuel and oxidizer past the main fuel/oxidizer ports largely eliminates the risk of the formation of an air or other non-combustible slug between the predetonator and main charges. Such a slug could prevent migration of the combustion front between the two charges.

With the charges introduced, the spark box is triggered to provide a spark discharge of the initiator igniting the predetonator charge. The predetonator charge being selected for very fast combustion chemistry, the initial deflagration quickly transitions to a detonation within the segment 84 and producing a detonation wave. Once such a detonation wave occurs, it is effective to pass through the main charge which might, otherwise, have sufficiently slow chemistry to not detonate within the conduit of its own accord. The wave passes longitudinally downstream and emerges from the downstream end 30 as a shock wave within the furnace interior, impinging upon the surfaces to be cleaned and thermally and mechanically shocking to typically at least loosen the contamination. The wave will be followed by the expulsion of pressurized combustion products from the detonation conduit, the expelled products emerging as a jet from the downstream end 30 and further completing the cleaning process (e.g., removing the loosened material). After or overlapping such venting of combustion products, a purge gas (e.g., air from the same source providing the main oxidizer and/or nitrogen) is introduced through the purge port 100 to drive the final combustion products out and leave the detonation conduit filled with purge gas ready to repeat the cycle (either immediately or at a subsequent regular interval or at a subsequent irregular interval (which may be manually or automatically determined by the control and monitoring system)). Optionally, a baseline flow of the purge gas may be maintained between charge/discharge cycles so as to prevent gas and particulate from the furnace interior from infiltrating upstream and to assist in cooling of the detonation conduit.

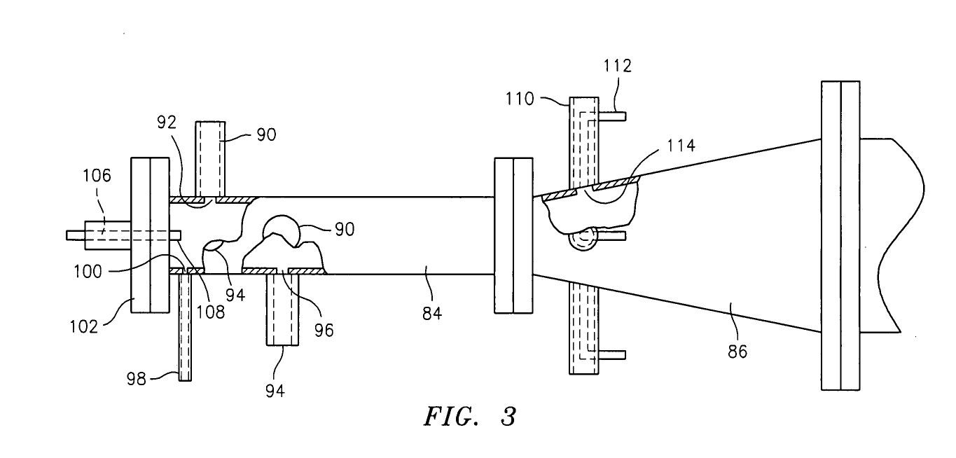

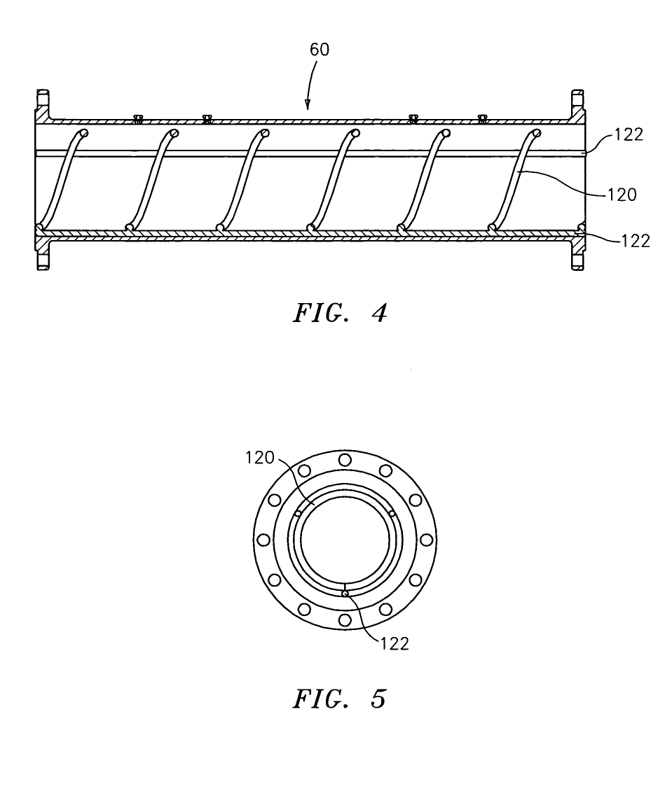

In various implementations, internal surface enhancements may substantially increase internal surface area beyond that provided by the nominally cylindrical and frustoconical segment interior surfaces. The enhancement may be effective to assist in the deflagration-to-detonation transition or in the maintenance of the detonation wave. FIG. 4 shows internal surface enhancements applied to the interior of one of the main segments 60. The exemplary enhancement is nominally a Chin spiral, although other enhancements such as Shchelkin spirals and Smirnov cavities may be utilized. The spiral is formed by a helical member 120. The exemplary member 120 is formed as a circular-sectioned metallic element (e.g., stainless steel wire) of approximately 8-20 mm in sectional diameter. Other sections may alternatively be used. The exemplary member 120 is held spaced-apart from the segment interior surface by a plurality of longitudinal elements 122. The exemplary longitudinal elements are rods of similar section and material to the member 120 and welded thereto and to the interior surface of the associated segment 60. Such enhancements may also be utilized to provide predetonation in lieu of or in addition to the foregoing techniques involving different charges and different combustor cross-sections.

The apparatus may be used in a wide variety of applications. By way of example, just within a typical coal-fired furnace, the apparatus may be applied to: the pendants or secondary superheaters, the convective pass (primary superheaters and the economizer bundles); air preheaters; selective catalyst removers (SCR) scrubbers; the baghouse or electrostatic precipitator; economizer hoppers; ash or other heat/accumulations whether on heat transfer surfaces or elsewhere, and the like. Similar possibilities exist within other applications including oil-fired furnaces, black liquor recovery boilers, biomass boilers, waste reclamation burners (trash burners), and the like.

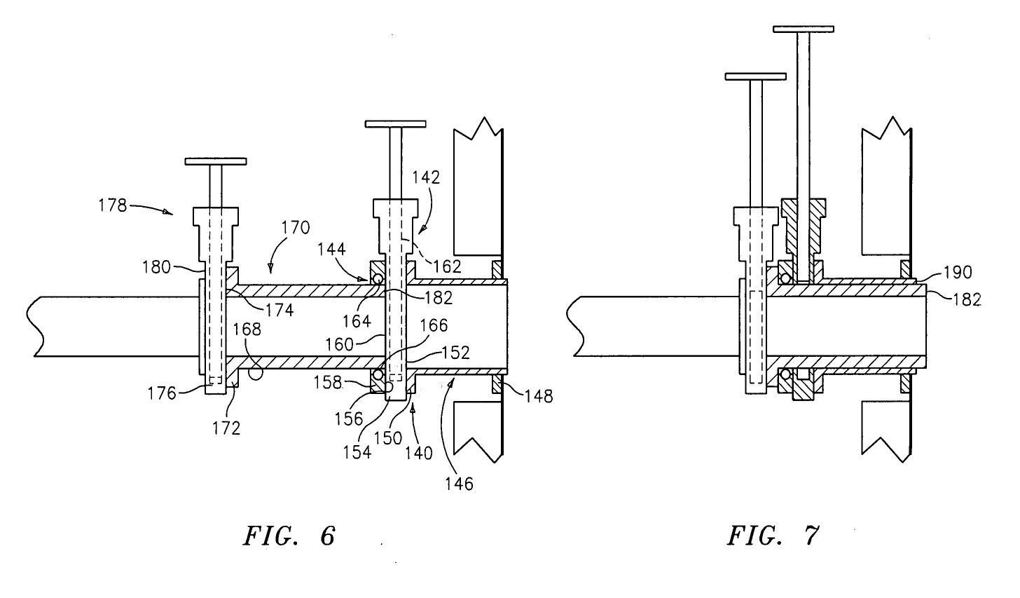

Various equipment operate under substantial differential pressure. For example, a positive pressure furnace will have interior pressures above ambient exterior pressures. This pressure difference imposes constraints on the ability to connect and disconnect soot blower components from the furnace while the furnace is in operation. Accordingly, a valve system may be provided for coupling soot blower equipment to the furnace. FIG. 6 shows a first access conduit assembly 140 mounted in (or alternatively otherwise at) an aperture in the furnace wall. The access conduit assembly includes a valve assembly (valve) and a seal assembly (seal) 144. In the illustrated embodiment, the access conduit assembly includes a spacer conduit 146 having an inboard (downstream) end flange 148 mounted relative to the furnace wall and an outboard (upstream) end flange 150 to which a downstream mating surface 152 of a body 154 of the valve is secured. A downstream surface 156 of a body of the seal is secured to the outboard/upstream surface 160 of the valve assembly body. The valve includes a gate 162 which may be manually or automatically (e.g., hydraulically or electromechanically) shifted between a closed configuration (e.g., position) blocking and sealing an aperture in the valve body and an open configuration at least partially clear of the valve aperture. The seal includes a sealing member (e.g., an O-ring) 164 having one or more sealing surfaces for sealingly engaging mating surfaces of an insertion portion of a combustion conduit. In the exemplary embodiment, the sealing surface is an inboard annular surface 166 of the sealing member which engages an outboard annular surface of a downstream insertion conduit 170.

In the exemplary embodiment, the insertion conduit has an upstream flange mounted to a downstream surface 174 of a body 176 of a second valve 178. The upstream surface 180 of the second valve body is mounted to a downstream main conduit section or segment of a soot blower combustion conduit (e.g., to the downstreammost segment 60 of FIG. 2). As with the first valve, the gate of the second valve has open and closed configurations for sealing the insertion conduit relative to the main segments of the detonation conduit.

In a hot install operation, with the furnace operating and the first and second valves closed, the insertion conduit (preferably as a unit with the rest of the combustion conduit) may be brought into alignment with the access conduit and inserted, a distal portion adjacent its downstream end 182 passing through the seal and sealing therewith. Depending on the particular implementation, further translation of the insertion may be unnecessary. In that case, the valves may be opened to permit soot blasting. To remove the insertion conduit, the valves may be closed and the insertion conduit withdrawn from the seal assembly. In other implementations, however, after the initial sealing insertion, the first valve may be opened with the second valve closed and the insertion conduit further inserted so as to pass through the first valve and optionally into the spacer conduit. FIG. 7 shows a situation wherein the end 182 has passed beyond the downstream end 190 of the spacer conduit and into the furnace interior. Thereupon the second valve may be opened to permit soot blower operation. Removal may be by a reverse of this process.

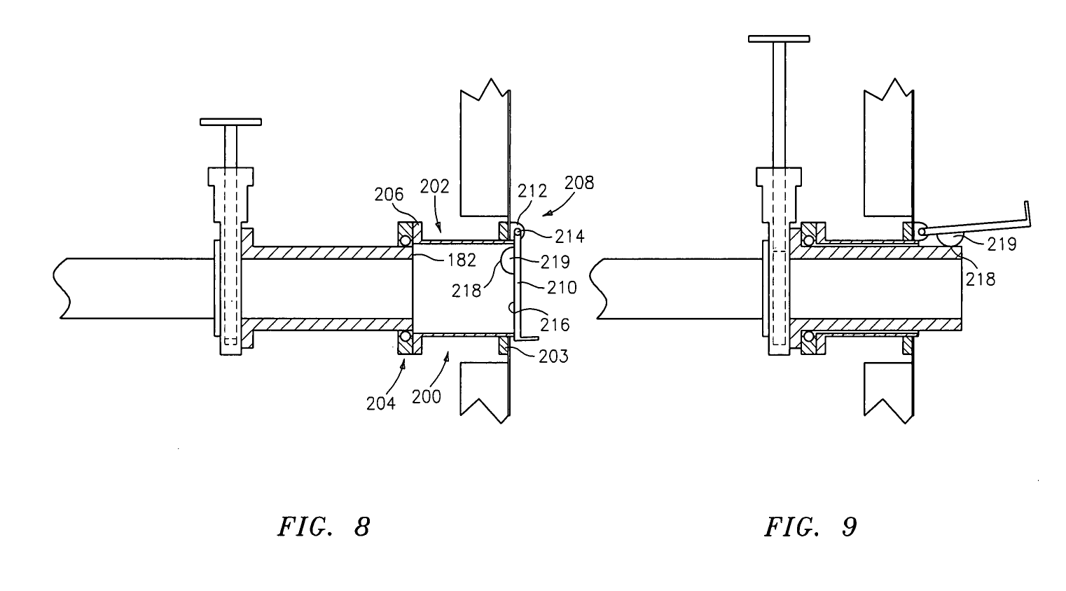

FIG. 8 shows an alternate system with a similar insertion conduit and second valve (thus similarly numbered) but an alternate access conduit assembly 200. The access conduit assembly 200 includes a spacer conduit 202 having a similar downstream flange 203 to that of FIG. 6 and a similar seal 204 to that of FIG. 6 secured to its upstream flange 206 in the absence of an intervening or associated valve. A first valve 208 is alternatively mounted at/near the downstream end of the spacer conduit. The exemplary first valve 208 is a hinged gate valve having a gate 210 and a hinge 212 pivotally mounting the gate for rotation about a hinge axis 214 between a closed configuration (e.g., orientation) blocking/sealing the downstream end of the access conduit and an open configuration. The exemplary first operated valve actuated by contact with the insertion conduit. In the exemplary embodiment, the insertion process may bring the downstream end 182 of the insertion conduit into contact with a the upstream surface or backside 216 of the gate, so that physical contact pressure between the two rotates the gate into an open orientation (FIG. 9), whereupon the second valve may be opened. For withdrawal, with the second valve closed, as the insertion conduit is withdrawn it permits the gate to close under spring bias or gravity bias. The exemplary engagement is of the downstream end 182 and exterior surface with a camming surface 218 of a projection 219 on the backside 216.

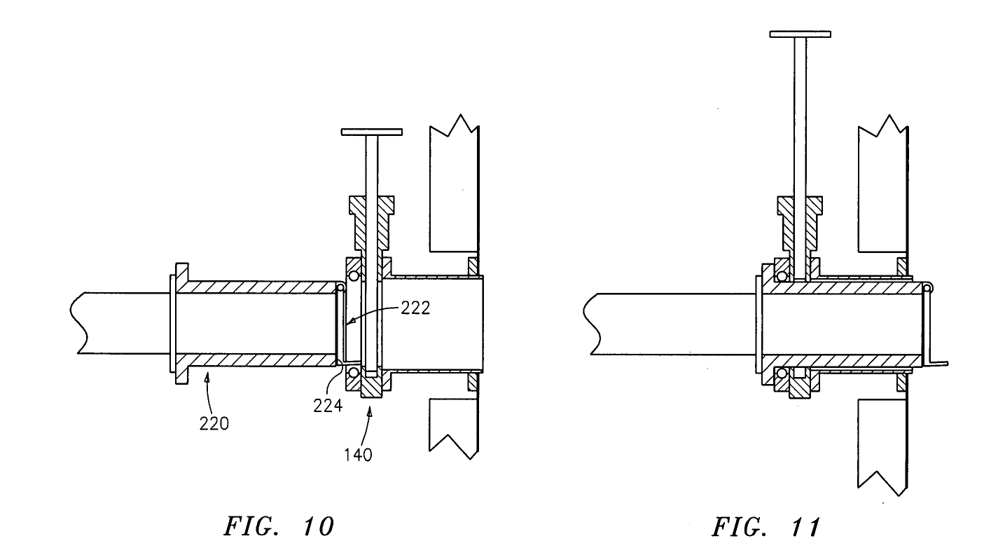

FIG. 10 shows yet another modification wherein the access conduit assembly is similar or identical to the first access conduit assembly (thus similarly numbered) but the insertion conduit lacks an upstream valve. Instead, a hinged gate second valve 222 is formed at the downstream end 224 of the insertion conduit. Engagement of the insertion conduit with the access conduit may be as described relative to the first embodiment. Once installed (FIG. 11), the second valve 222 may be opened by means of an actuation mechanism (not shown) such as a linkage or a cable within the wall of the insertion conduit.

Although illustrated heretofore with coaxial interior and exterior surfaces, the insertion conduit may have other arrangements (e.g., for directing the soot blower output in a desired direction). For example, FIG. 12 shows an insertion portion 230 having an interior surface 232 which is a non-right cylindrical surface whose axis 520 is off-parallel (e.g., by 5-30°) to the axis 522 (which may be parallel to the axis/centerline 500) of the right circular cylindrical exterior surface. FIG. 18 shows an access conduit 240 and insertion portion 242 with inner and outer surfaces coaxial about an axis 530 off-normal (e.g., by 5-45°) to the wall through which they extend.

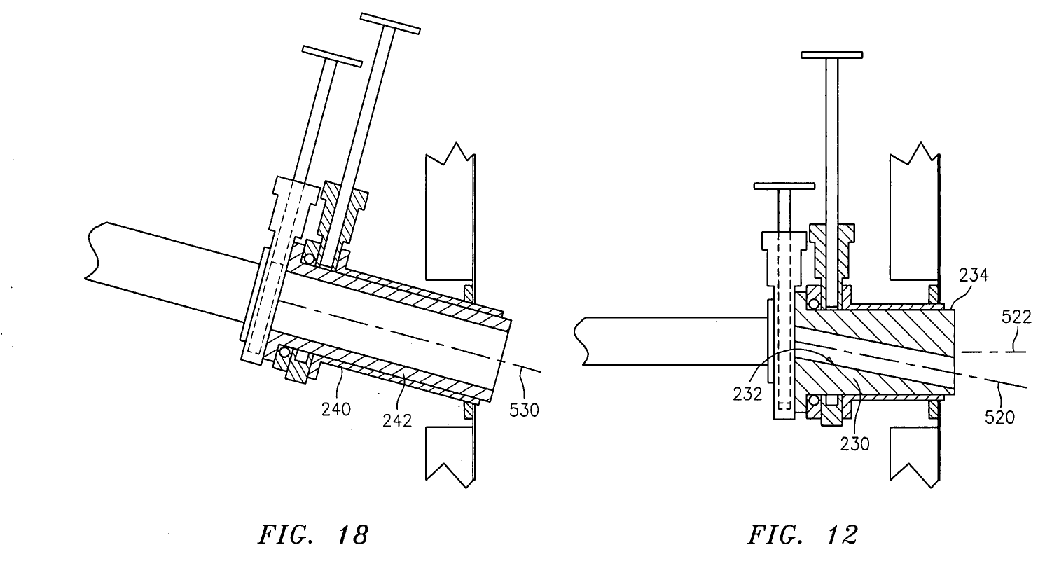

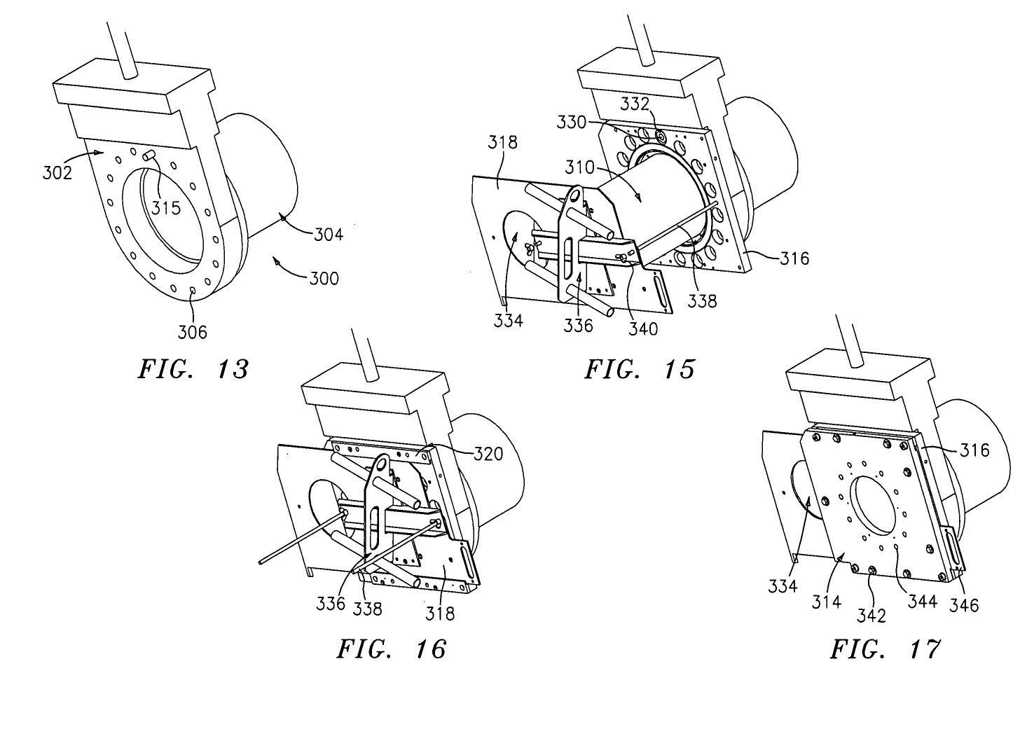

FIG. 13 shows an access conduit assembly 300 including a gate type access valve 302 and a spacer conduit 304. The spacer conduit is dimensioned to extend through a vessel wall aperture and is secured at its upstream end to the valve 302. The body of the exemplary access valve 302 has an array of blind threaded holes 306 for rigidly mounting a conduit valve (discussed below) to the access valve.

FIG. 14 shows an insertion conduit/nozzle and conduit valve assembly 308. The assembly 308 includes a double walled nozzle 310 which, in operation, may pass a cooling gas from upstream to downstream into the vessel between the nozzle walls (e.g., as is described in copending application attorney docket EH-10964 (03-434) filed on even date herewith and the disclosure of which is incorporated by reference herein as if set forth at length). The nozzle 310 has an upstream flange 312 which, upon assembly (as described below), is captured between upstream and downstream halves 314 and 316 of a body of the conduit valve. The conduit valve further includes a gate 318 and a pair of guide rails 320. A gasket 322 may seal between the access valve body upstream face and the conduit valve body downstream face.

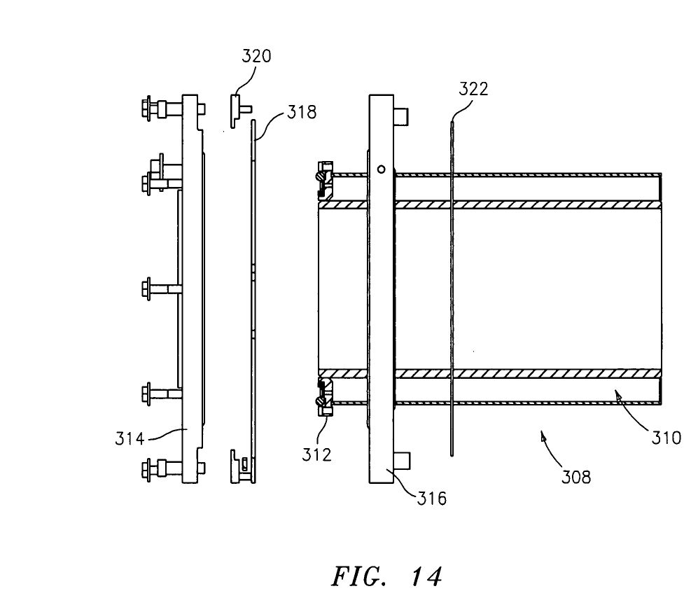

In an exemplary sequence of assembly, the access valve 302 has been preinstalled to the vessel (e.g., when the vessel is built or during a shutdown thereof). Remaining assembly steps may be performed hot (e.g., with the vessel in operation). The access valve is initially in its closed condition. One or more threaded studs 330 (FIG. 13) may be engaged to the holes 306. The gasket 322 may be put in place. The conduit valve body downstream half 316 may be put in place with counterbored holes receiving the studs and nuts 332 (FIG. 15) secured to the studs within the counterbores so as to firmly bolt the valve half 316 to the access valve body. The nozzle 310 may initially be mounted to the gate 318 with the gate blocking the nozzle upstream end. The exemplary gate includes an aperture 334 initially not registered with the nozzle. The nozzle may be held to the gate by a mounting tool 336 on the upstream face of the gate and having bolts extending through the gate into the nozzle flange 312. Threaded guide rods 338 may initially be secured at downstream ends to threaded holes in the valve half 316. The guide rods may pass through holes in the tool 336 and the tool may be retained thereon by nuts 340. The nuts may be tightened to gradually bring the nozzle 310 through the valve half 316 and into the access valve until forming a seal with access valve seals (not shown). The seal may be supplemented by connection of an air purge line (not shown) to a port in the valve half 316 to apply pressure between that half and the nozzle. When the nozzle downstream end reaches the gate of the access valve, the access valve may be opened. The pressure applied via the air purge lie helps prevent furnace gas leakage around the nozzle. Similarly, an additional air purge line (also not shown) may be connected to a port in the access conduit body or flange to further help prevent furnace gas leakage. Further tightening of the nuts 340 further inserts the nozzle 310 guided by the rods 338 and tool 336. Eventually, the tightening brings the gate 318 into engagement with the valve half 316, the gate downstream face lying flat against the upstream face of that valve half and optionally sealed by means of a seal (not shown). The guide rails 320 (FIG. 16) may then be installed (e.g., by bolting to the conduit valve downstream half 316 to capture the gate 318 and prevent upstream shifting thereof). The tool 336 and threaded rods 338 may then be removed. The gate 318 will remain in place retained by the rails 320. The conduit valve body upstream half 314 may then be installed via bolts 342 (FIG. 17) extending around the gate into threaded apertures in the downstream half 316. The upstream half 314 has threaded apertures 344 into which studs (not shown) may be inserted and the downstream flange of the adjacent conduit section secured. The remaining conduit sections may have been preassembled with the adjacent conduit section as a unit or may be further built up. With the conduit fully assembled, the conduit valve may be opened (e.g., via a handle 346 which translates the gate to align the aperture 334 with the conduit interior). Disassembly may be via a substantial reverse of this process. In alternate embodiments, the conduit valve may be omitted and upstream conduit sections secured directly to the access valve (with or without an insertion conduit).

One or more embodiments of the present invention have been described. Nevertheless, it will be understood that various modifications may be made without departing from the spirit and scope of the invention. For example, the invention may be adapted for use with a variety of industrial equipment and with variety of cleaning technologies. Aspects of the existing equipment and technologies may influence aspects of any particular implementation. Accordingly, other embodiments are within the scope of the following claims.

1. An apparatus for providing detonative cleaning communication through a vessel wall comprising:
a first conduit extending from the vessel wall;
a first valve having an open condition permitting communication through the first conduit and a closed condition; and
a second conduit having an insertion portion dimensioned to be received within a receiving portion of the first conduit; and
a second valve having an open condition permitting communication through the second conduit and a closed condition.

2. The apparatus of claim 1 wherein:
the first valve is a sliding gate valve; and
the second valve is a sliding gate valve.

3. The apparatus of claim 1 wherein:
one of the first and second valves is a sliding gate valve; and
the other of said first and second valves is a hinged gate valve.

4. The apparatus of claim 1 wherein:
one of the first and second valves is a manually-actuated or machine-actuated valve; and
the other of said first and second valves is a manually-actuated or machine-actuated valve.

5. The apparatus of claim 1 further comprising:
means for sealing the first conduit relative to the second conduit over a first range of insertion of the second conduit within the first conduit.

6. The apparatus of claim 1 wherein:
the second conduit has an interior surface off-axis to an exterior surface.

7. An apparatus for providing detonative cleaning communication through a vessel wall comprising:
a conduit defining a flow path through the vessel wall; and
a valve along the flow path and having an open condition and a closed condition.

8. The apparatus of claim 7 further comprising:
a source of fuel and oxidizer coupled to the conduit;
means for igniting charges of the fuel and the oxidizer.

9. The apparatus of claim 7 wherein:
the valve is secured relative to the wall;
the valve is along a downstream half of the flow path.

10. The apparatus of claim 7 wherein:
the valve is a first valve at an upstream end of an access conduit; and
the apparatus includes a second valve along the conduit upstream of the first valve and upstream of an insertion portion of the conduit within the access conduit.

11. The apparatus of claim 7 wherein:
the valve is a first valve between a main portion of the conduit and a downstream insertion portion of the conduit; and
the apparatus includes a second valve at an upstream end of an access conduit receiving the insertion portion.

12. A method for cleaning a vessel, the vessel having a wall and an access conduit initially sealed by a first valve, the method comprising:
inserting an insertion portion of a combustion conduit into the access conduit, the combustion conduit having a second valve;
forming a seal between the access conduit and the combustion conduit;
opening the first valve;
opening the second valve;
passing combustion gasses through the combustion conduit into the vessel; and
withdrawing the insertion portion from the access conduit.

13. The method of claim 12 wherein:
the opening of the first valve occurs during an intermediate stage of said insertion.

14. The method of claim 12 further comprising:
forming a seal between the combustion conduit and the access conduit.

15. The method of claim 14 wherein:
the forming of the seal occurs before the opening of the first valve.

16. The method of claim 12 wherein:
the opening of one of the first and second valves comprises a pivotal movement of a gate of said one valve; and
the opening of the other valve is manual.
